(19) United States
(12) Patent Application Publication
(10) Pub. No.: US 2012/0164909 A1
(43) Pub. Date: Jun. 28, 2012

(54) DISPLAY DEVICE MANUFACTURING METHOD AND APPARATUS

(75) Inventors: Yukihiko OHASHI, Kawasaki (JP); Hirokazu YAMANISHI, Kawasaki (JP)

(73) Assignee: Fujitsu Limited, Kawasaki (JP)

(21) Appl. No.: 13/275,792

(22) Filed: Oct. 18, 2011

(30) Foreign Application Priority Data
Dec. 28, 2010 (JP) 2010-292270

(51) Int. Cl. H01J 9/00

(52) U.S. Cl. 445/24; 445/60

(57) ABSTRACT

The present disclosure is directed to a method of manufacturing a display device including a first substrate including a conductive layer and a terminal, a second substrate, and a display element disposed between the first substrate and the second substrate.

The first substrate and the second substrate are bonded together.

A groove is formed in the second substrate, the groove defining a border of a facing section facing the terminal of the first substrate.

The groove may be formed before bonding the first substrate and the second substrate together.

A nail member is inserted into a gap between the facing section of the second substrate and the terminal of the first substrate, and the nail member is moved to a direction including a component in a direction vertical to an extending direction of the groove.

### CROSS-REFERENCE TO RELATED APPLICATION

This application is based upon and claims the benefit of priority of the prior Japanese Patent Application No. 2010-292270, filed on Dec. 28, 2010, the entire contents of which are incorporated herein by reference.

### FIELD

The embodiment disclosed herein is related to a technique for manufacturing a display device including a display element sandwiched between substrates.

### BACKGROUND

Display devices including a display element sandwiched between two substrates have been well known. Such a display device includes conductive film patterns (circuit patterns) formed on the respective substrates, wherein the display functionality is achieved by applying signal voltages to a display element sandwiched between the two conductive film patterns.

Conductive films in a typical display device have a matrix (lattice) pattern wherein vertically extending interconnection lines are overlaid with horizontally extending interconnection lines. For example, the conductive film pattern on a first substrate is defined by parallel interconnection lines, and the conductive film pattern on a second substrate is defined by interconnection lines extending vertically to the first interconnection lines. The substrates are overlaid such that interconnection lines orthogonally intersect with each other, which allow application of a signal voltage any locations (pixels) of the display element sandwiched between the two conductive film patterns.

Electrode terminals are provided at an end of the conductive film pattern for receiving a signal voltage from an external substrate or a driving circuit for controlling the display device, and a connector of a flexible cable or the like is connected to those electrode terminals. Since the electrode terminals are enclosed between the two overlaid substrates, a portion of a substrate facing the electrode terminals is usually removed before connecting a connector to the terminals during the manufacturing of the display device. However, in order to assure the rigidity and strength of the substrates and to protect the electrode terminals, it is preferable to expose the electrode terminals immediately before connecting to the connector, rather than exposing the electrode terminals beforehand.

For this purpose, a method has been proposed, which includes forming a half-cut line defining an edge of a portion of one substrate which is to be removed, bonding two substrates, and exposing the electrode terminals by cutting the substrate along the half-cut line. As used herein, the term “half-cut line” refers to a groove-like structure, wherein the thickness of the substrate in the groove is smaller than the thickness of the remainder of the substrate. A cutting process of the half-cut line is performed, by jetting compressed air from an air nozzle to create a gap between the substrates, inserting a blade (knife) into the gap, and contacting the blade to the substrate to cut the substrate along the half-cut line, for example. (See Japanese Laid-open Patent Publication No. 2000-321561)

However, since the electrode terminals are located in the vicinity of the half-cut line, there is a possibility that the blade accidentally contacts the electrode terminals unless the movement of the blade is precisely controlled. Particularly when compressed air is used to facilitate the insertion of the blade, the blade may drift due to the air pressure, making it difficult to improve a precision of positioning of the blade. Any variation in the cut resistance may significantly affect the precision of positioning the blade. On the other hand, since the cut resistance may vary depending on the profile of the blade tip and the smoothness of the contact area between the blade and the substrate, which makes maintenance of a constant cut resistance difficult. This is also one of the factors hindering any improvement in the precision of positioning the blade.

Furthermore, the above-described cutting technique is difficult to be applied for curved half-cut lines. More specifically, driving the blade along the curve of the half-cut line may request a drive mechanism and a control configuration which are complex. Furthermore, additional time for driving the blade is preferably needed in the manufacturing process, which may hinder improvement in the productivity.

Furthermore, in the above-described cutting technique, since a half-cut line is formed by means of the shear force induced upon contact between the substrate and the blade, the blade may be precisely aligned with the half-cut line upon the contact. This situation calls for a precise formation of the half-cut line, as well as calling for a highly precise positioning of the blade. If a half-cut line were drifted due to some machining error, the shear force would be applied to an area of the substrate other than the half-cut line. If this happens, the substrate may be cut in an area other than the half-cut line, leaving the unwanted portion of the substrate. That unwanted portion may be removed manually, for example, which further lengthens the manufacturing time and increases the work load. Furthermore, the shear force applied to the unintended area may deform the substrate or the conductive film pattern.

As described above, the conventional technique for manufacturing display devices is facing a challenge of improving the reliability of products while enhancing the yield.

### SUMMARY

An aspect of the embodiment provides a method of manufacturing a display device including a first substrate including a conductive layer and a terminal, a second substrate, and a display element disposed between the first substrate and the second substrate. This method includes bonding the first substrate and the second substrate together, and forming a groove in the second substrate, the groove defining a border of a facing section facing the terminal of the first substrate.

Furthermore, the method includes inserting a nail member into a gap between the facing section of the second substrate and the terminal of the first substrate. The method also includes moving the nail member to a direction including a component in a direction vertical to an extending direction of the groove, and jetting first gas to the gap.

The object and advantages of the embodiment will be realized and attained by means of the elements and combinations particularly pointed out in the claims. It is to be understood that both the foregoing general description and the following detailed description are exemplary and explanatory and are not restrictive of the embodiment, as claimed.

### BRIEF DESCRIPTION OF DRAWINGS

FIG. 1 is an exploded perspective view depicting a display device manufactured using a manufacturing apparatus and a method of manufacturing a display device according to an embodiment;

FIG. 2 is a perspective view depicting an enlarged view of the main portion of the display device in FIG. 1;

FIG. 3A is a cross-sectional view illustrating a cross-section of the display device in FIG. 1 (cross-sectional view along Line A-A in FIG. 2);

FIG. 3B is a cross-sectional view illustrating a variant of the structure in FIG. 3A;

FIG. 4 is a perspective view illustrating a manufacturing apparatus of a display device according to an embodiment;

FIG. 5 is a cross-sectional view during operation of the manufacturing apparatus in FIG. 4 (cross-sectional view along Line B-B in FIG. 4);

FIG. 6 is a side view for illustrating the operation of the manufacturing apparatus in FIG. 3;

FIG. 7 is a graph for illustrating the operation of the manufacturing apparatus in FIG. 3;

FIG. 8A is a perspective view depicting a manufacturing apparatus of a display device according to a variant;

FIG. 8B is a side view of a manufacturing apparatus of a display device according to a variant (in the direction of Arrow C in FIG. 8A);

FIG. 9A is a perspective view illustrating a manufacturing apparatus of a display device according to a variant;

FIG. 9B is a top view of a manufacturing apparatus of a display device according to a variant (in the direction of Arrow D in FIG. 9A);

FIGS. 10A and 10B are flowcharts illustrating a method of manufacturing a display device according to an embodiment; and

FIGS. 11A and 11B are perspective views depicting variants of the display device in FIG. 1.

### DESCRIPTION OF EMBODIMENTS

Hereinafter, an embodiment of a method of manufacturing and a manufacturing apparatus of a display device will be described with reference to the drawings. Note that the embodiment described below is described by way of example only, and various modifications and applications of techniques that are not provided explicitly in the following embodiment are not intended to be excluded. That is, the present embodiment can be practiced in various ways (by combining the embodiment and the variants, for example) without departing from the spirit thereof.

1. Display Device

A manufacturing apparatus of a display device (display device manufacturing apparatus) according to an embodiment is adapted to manufacture a display device. The term “display device” includes liquid crystal display devices and light-emitting display devices, such as light-emitting diode (LED) light-emitting devices, organic luminescent display devices, electronic paper (cholesteric liquid crystal displays, electrophoresis displays), digital micro mirror devices (DMDs), plasma display panels (PDPs), and field emission displays (FEDs).

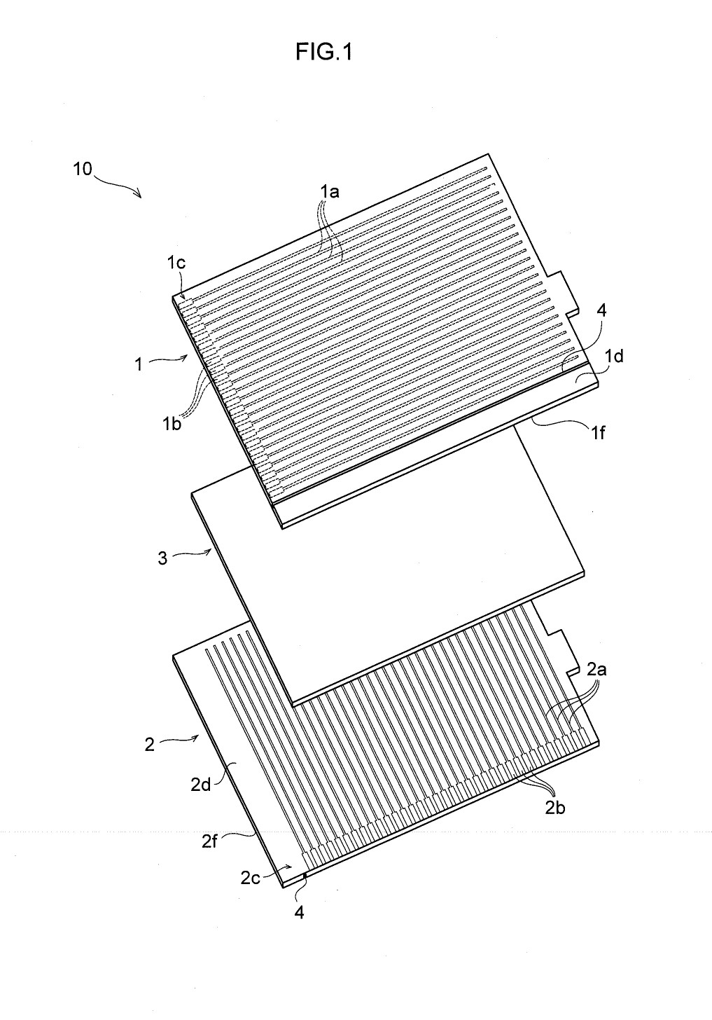

FIG. 1 is an exploded perspective view illustrating a display device 10 which includes two films 1 and 2 and a liquid crystal layer 3 (display element) that is sandwiched between the two films and functions as electronic paper. The term “electronic paper” as used herein refers to a display element which consumes power only for writing or erasing contents to be displayed, while requesting no power for keeping the once-displayed contents.

The films 1 and 2 are highly transparent plastic films, made from polycarbonate (PC) or polyethylene terephthalate (PET), for example. The films 1 and 2 have thicknesses about 0.1 to 1.0 mm, for example. A transparent electrode layer (conductive layer) is formed on each surface of the films 1 and 2. In FIG. 1, the transparent electrode layer on the film 1 (first substrate) is disposed on the back surface, while the transparent electrode layer on the film 2 (second substrate) is disposed on the front surface.

A conductive film pattern having multiple parallel interconnection lines la is formed in the transparent electrode layer on the film 1. Each interconnection line 1a extends along the longitudinal direction of the display device 10 (for example, vertical direction). The number of interconnection lines 1a is determined depending on the longitudinal resolution of the display device 10. An electrode terminal 1b is also provided at an end of each interconnection line 1a for receiving a signal voltage from an external substrate or a drive circuit controlling the display device. Hereinafter, the region wherein the electrode terminals 1b are provided along the edge of the film 1 is referred to as a terminal section 1c, and the side perpendicular to the edge wherein the terminal section 1c is formed is referred to as a longitudinal side 1f. A connector of a flexible cable is connected to the electrode terminals 1b in the terminal section 1c, for example.

Similarly to the transparent electrode layer on the film 1, a conductive film pattern having multiple parallel interconnection lines 2a is formed in the transparent electrode layer on the film 2. Each interconnection line 2a in the film 2 extends along the direction vertical (perpendicular) to the extending direction of the interconnection lines 1a on the film 1, and is the lateral direction of the display device 10 (for example, horizontal direction). The number of interconnection lines 2a is determined depending on the lateral resolution of the display device 10. Similar to interconnection lines 1a, an electrode terminal 2b is provided at an end of each interconnection line 2a. Hereinafter, the region wherein the electrode terminals 2b are provided along the edge the film 2 is referred to as a terminal section 2c, and the side perpendicular to the edge wherein the terminal section 2c is formed is referred to as a lateral side 2f. The terminal section 1c of the film 1 and the terminal section 2c of the film 2 are provided such that they do not overlap with each other.

The liquid crystal layer 3 is sandwiched between the transparent electrode layers on the films 1 and 2. The liquid crystal layer 3 is provided with cholesteric liquid crystal that changes its property, so as to transmit or reflect incident light of a certain wavelength. The cholesteric liquid crystal transmits or reflects the incident light, depending on a voltage applied thereto. The liquid crystal layer 3 has a thickness of (i.e., the gap between the films 1 and 2 is) about 0.01 mm.

Once the two films 1 and 2 are bonded together, the interconnection lines 1a and 2a define a matrix (lattice), when viewed vertically from to the surfaces of the films 1 and 2. This allows a signal voltage to be applied to any locations (pixels) of the liquid crystal layer 3 defined by the interconnection lines 1a and 2a.

As depicted in FIG. 1, a facing section 1d is defined on the surface of the film 1, wherein no interconnection line 1a is present. The facing section 1d faces the terminal section 2c of the film 2. Similarly, a facing section 2d is defined on the surface of the film 2, facing the terminal section 1c of the film 1. The facing section 1d of the film 1 extends along the longitudinal side 1f in the longitudinal direction of the display device 10, whereas the facing section 2d of the film 2 extends along the lateral side 2f in the lateral direction of the display device 10.

A groove-like half-cut line 4 (groove) is formed in an outer surface 1e of the surface of the film 1, which is the side oppose to the inner surface on which the transparent electrode layer is formed. The half-cut line 4 is provided substantially parallel to the longitudinal side 1f of the film 1 so as to define a border of the facing section 1d. For example, once the two films 1 and 2 are bonded together, the electrode terminals 2b in the film 2 are enclosed by the periphery of the film 1 and the half-cut line 4, when viewed vertically from to the surfaces of the films 1 and 2. Similarly, another groove-like half-cut line 4 is formed on the outer surface of the film 2. The half-cut line 4 is proved along one side of the film 2 in the lateral direction and substantially parallel to the lateral side 2f, so as to define a border of the facing section 2d.

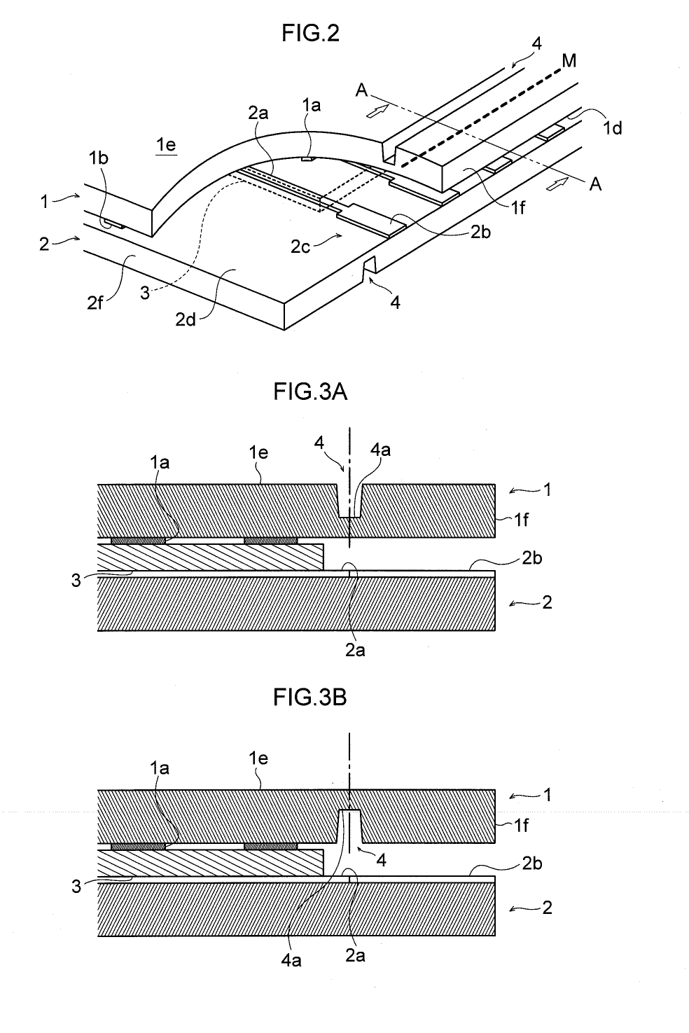

FIG. 2 is a diagram schematically depicting the two films 1 and 2 bonded together, wherein a portion of the film 1 is cut. Here, the liquid crystal layer 3 sandwiched between the interconnection lines 1a on the film 1 and the interconnection lines 2a on the film 2 is depicted in the broken line. The half-cut line 4 in the film 1 extends in the direction wherein the electrode terminals 2b extend (along the longitudinal side 1f of the film 1) such that the electrode terminals 2b in the film 2 are exposed after the facing section 1d is removed. Similarly, the half-cut line 4 in the film 2 extends in the direction wherein the electrode terminals 1b extend (along the lateral side 2f of the film 2) such that the electrode terminals 1b in the film 1 are exposed after the facing section 2d is removed.

The half-cut line 4 is a recess (dent, channel, groove) with a square C-shaped cross section extending from the outer surface 1e into the film 1, as depicted in FIG. 3A, for example. The half-cut line 4 is formed with a knife or a laser irradiation apparatus, for example. In a configuration wherein a laser irradiation apparatus is used, the power and the focus of the laser are controlled such that the outer surface 1e is gouged out but a certain thickness of the film 1 is remained.

The thinner the portion extending from the bottom face 4a of the half-cut line 4 to the surface of the facing section 1d becomes, the more easily a tear can be generated in the thinner portion, facilitating removal of the facing section 1d from the film 1. A half-cut line 4 may be formed on the inner surface of the films 1 and 2, as depicted in FIG. 3B, or two half-cut lines 4 may be formed on both the outer and inner surfaces, or a groove-like air gap may be defined inside the film 1.

2. Manufacturing Apparatus

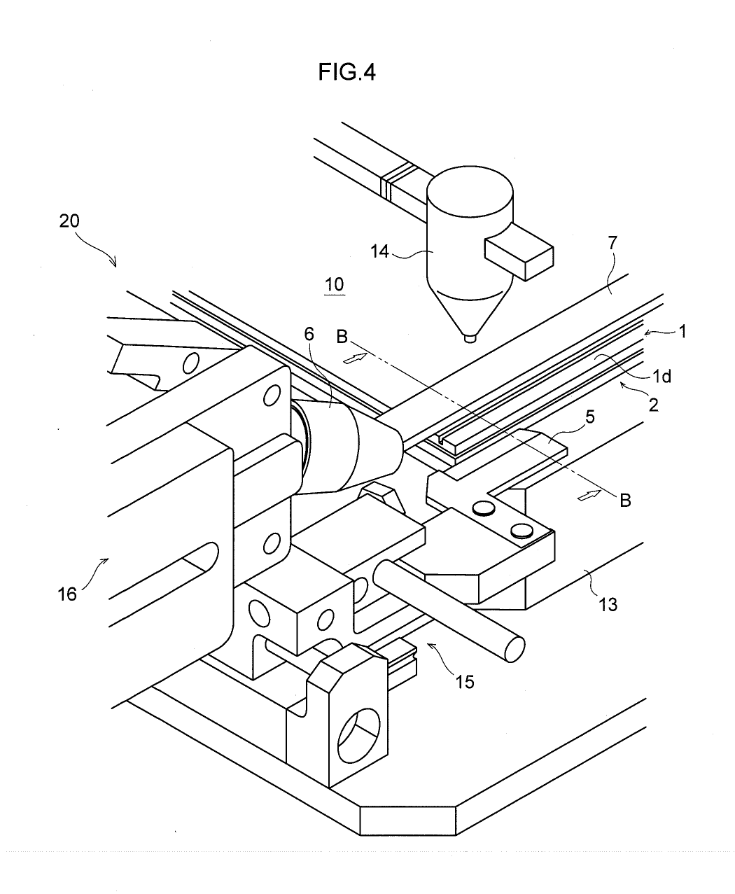

FIG. 4 is a perspective view illustrating a manufacturing apparatus 20 of a display device 10 according to an embodiment. The manufacturing apparatus 20 includes a pressing guide 7, a laser irradiation apparatus 14, a blade 5, and an air nozzle 6. The manufacturing apparatus 20 is used in a step of exposing the electrode terminals 1b and 2b on the films 1 and 2, after the two films 1 and 2 are bonded together.

The pressing guide 7 secures the display device 10 on the working table 13. The working table 13 may be horizontally placed on a desk, and the display device 10 having the two bonded films 1 and 2 is placed on the working table 13, for example. The pressing guide 7 is adapted to press the display device 10 against the working table 13 to secure the display device 10 thereon. The pressing guide 7 presses at least a portion of the display device 10 other than the facing section 1d of the film 1.

2-1. Laser Irradiation Apparatus

The laser irradiation apparatus 14 (processing unit) is a cutting apparatus to form a half-cut line 4 in the film 1 in the display device secured on the working table 13. For example, laser light is applied on the outer surface 1e of the film 1 to melt and evaporate the resin, to form a void. Subsequently, the application area of the laser light is moved (displaced, shifted) along the pressing guide 7 to form a groove-like half-cut line 4. An aiming point of the laser light moves along the pressing guide 7.

This step of forming the half-cut line 4 may be performed before bonding the two films 1 and 2. In this case, each of the films 1 and 2 before bonding may be secured to the working table 13, and the laser irradiation apparatus 14 may form respective half-cut lines 4 in the films 1 and 2 by applying laser light. After bonding the two films 1 and 2 each having the half-cut line 4, the subsequent step of exposing the electrode terminals 1b and 2b may be performed.

2-2. Blade

The blade 5 (nail member) is a plane member that generates a tear in the thinner portion between the bottom face 4a of the half-cut line 4 and the surface of the facing section 1d. The tip of the blade 5 is configured to be thinner than the gap between the bonded films 1 and 2. A blade drive mechanism 15 is provided at the proximal side of the blade 5 for rotating the entire blade 5. Note that the blade 5 in this embodiment is not in a knife-shape. For example, the blade 5 may be made from a ceramic or a resin, or may be made form a metal. That is, cutting function is not fundamental function for the blade 5.

The blade drive mechanism 15 enables two types of operation of the blade 5. The first operation is a horizontal operation wherein the blade 5 is inserted into the gap between the facing section 1d of the film 1 and the terminal section 2c of the film 2. As depicted in FIG. 5, the direction of the insertion of the blade 5 is horizontal, and is vertical to the extending direction of the half-cut line 4 (left direction in FIG. 5). The blade drive mechanism 15 inserts the blade 5 under the facing section 1d such that at least “a distance d” is maintained between the blade 5 and the electrode terminals 2b in the film 2. For example, the blade drive mechanism 15 drives (translates, displaces) the blade 5 so as to reduce the horizontal distance between the tip of the blade 5 and the half-cut line 4 while keeping the tip of the blade 5 to be parallel to the half-cut line 4.

The second operation is a rotation operation wherein the blade 5 is raised toward the facing section 1d. The center of the rotation of the blade 5 may be an axis P, the axis P locating between the films 1 and 2 under the half-cut line 4 and being parallel to the half-cut line 4, for example, as depicted in FIG. 5. In this case, during the rotation of the blade 5 to the position depicted in the broken line, a tensile force is induced in the thinner portion between the bottom face 4a of the half-cut line 4 and the surface of the facing section 1d, thereby generating a tear. In the example depicted in FIG. 5, the rotation angle is about 100°.

The rotation angle about the axis P and the displacement distance of the blade 5 are determined depending on the tensile strength and the ductility of the film 1, such that a tear is generated in the thinner portion between the bottom face 4a and the surface of the facing section 1d. For example, as the harder and the more fragile the film 1 is, or the deeper the half-cut line 4 is (the narrower the thinner portion is), the smaller the rotation angle and the displacement distance can be.

The blade 5 can be driven to any direction as long as at least the facing section 1d is raised, and as long as that direction is vertical to the extending direction of the half-cut line 4 and is not parallel to the insertion direction of the blade 5, for example. The two types of operation of the blade 5 may be activated by a manual operation with intervention of an operator, or may be activated by an automatic operation under an autonomous control of the blade drive mechanism 15.

2-3. Air Nozzle

The air nozzle 6 (jetting unit) is adapted to jet compressed air (hereinafter, simply referred to as “air”) toward the gap between the facing section 1d of the film 1 and the terminal section 2c of the film 2. The jetting pressure and the jetting flow rate of the air are variably controlled by a control unit (not illustrated). The air jetted from the air nozzle 6 plays two major roles. The first role is to facilitate insertion of the blade 5 into the gap between the facing section 1d of the film 1 and the terminal section 2c of the film 2. In other words, the air jetted toward the gap widens that gap. To play this first role, the air nozzle 6 jets the air before or while the blade drive mechanism 15 drives the blade 5 in the horizontal direction. Hereinafter, the air jetted for widening the gap is referred to as second air (second gas).

The second role is to lengthen the tear generated during the rotation of the blade 5, and to extend that tear along the half-cut line 4. In other words, the sheet is cleaved in the half-cut line 4 by means of the air blown to the gap. To play the second role, the air nozzle 6 jets the air after the blade drive mechanism 15 rotates the blade. Hereinafter, the air jetted for cleaving the sheet in the half-cut line 4 is referred to as first air (first gas). The first and second air may have the same compression pressure, or the jetting pressure of the second air may be higher than that of the first air. The compositions of the first and second gases may be different.

The air jetted from the air nozzle 6 preferably targets the vicinity of the cleaving point on the half-cut line 4, wherein the sheet is cleaved. For example, the air is targeted on a point somewhat proximal to the cleaving point on the half-cut line 4 (i.e., the point closer to the area that has already been cleaved than the actual cleaving point). In other words, the air may be targeted on the point between the two films 1 and 2 when viewed from the side, and closer to the area that has already been cleaved than the actual cleaving point on the half-cut line 4 when viewed from the top. Alternatively, the air may be targeted on the point somewhat closer to the facing section 1d than the actual cleaving point (i.e., the point suitable for strongly displacing the curled up facing section 1d upward).

Furthermore, the jetting opening of the air nozzle 6 may be positioned to any point on a line that extends in the extending direction of the facing section 1d right above the facing section 1d of the film 1. For example, as depicted in FIG. 2, when considering the central line M (depicted in thick broken line) vertical to the extending direction of the facing section 1d (width direction) on the outer surface 1e, the center of the jetting opening of the air nozzle 6 is positioned within the vertical plane including this central line M. In this case, the jetting direction of the air is parallel to the extending direction of the half-cut line 4, i.e., the extending direction of the facing section 1d of the film 1, when viewed from the top.

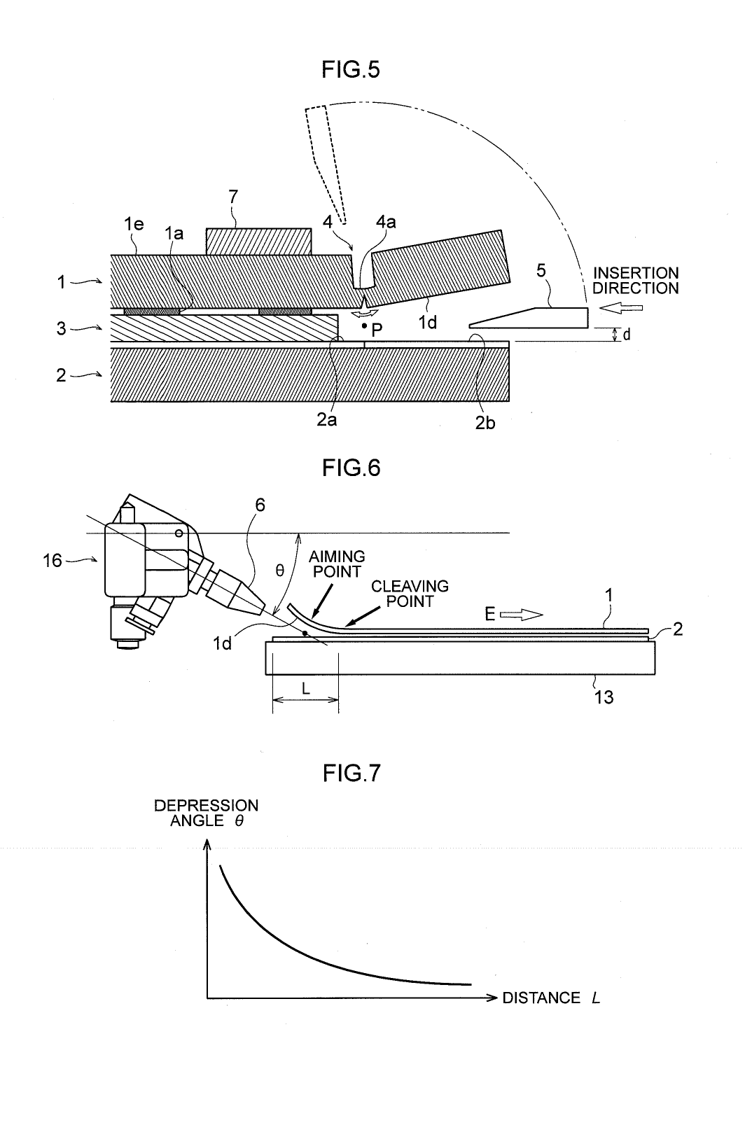

Hereinafter, as depicted in FIG. 6, the jetting direction of the air nozzle 6 with respect to the horizontal plane will be denoted by the depression angle θ, and the cleaving point of the half-cut line 4 from its initial cleaving point will be denoted by the horizontal distance L. As depicted in FIG. 7, the horizontal distance L correlates with the depression angle θ, such that the greater the horizontal distance L is, the smaller the depression angle θ become, for example.

The two roles of the air nozzle 6 may be activated by a manual operation with intervention of an operator, or may be activated by an automatic operation under an autonomous control of an air nozzle drive mechanism 16. When an automatic control is employed, a detection unit for detecting the horizontal distance L may be provided, wherein the air nozzle drive mechanism 16 may control the depression angle θ in accordance with the detected horizontal distance L.

2-4. Detection Unit

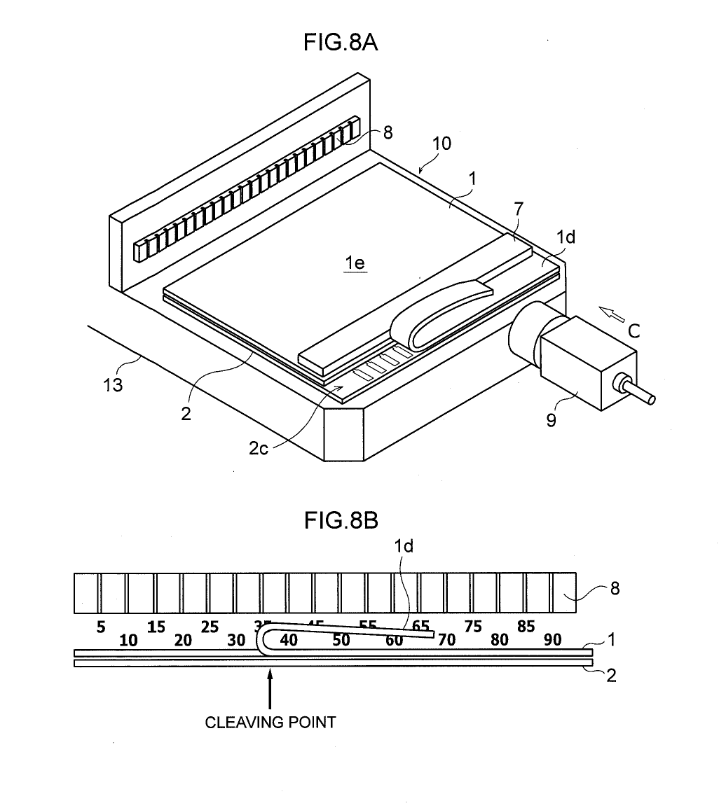

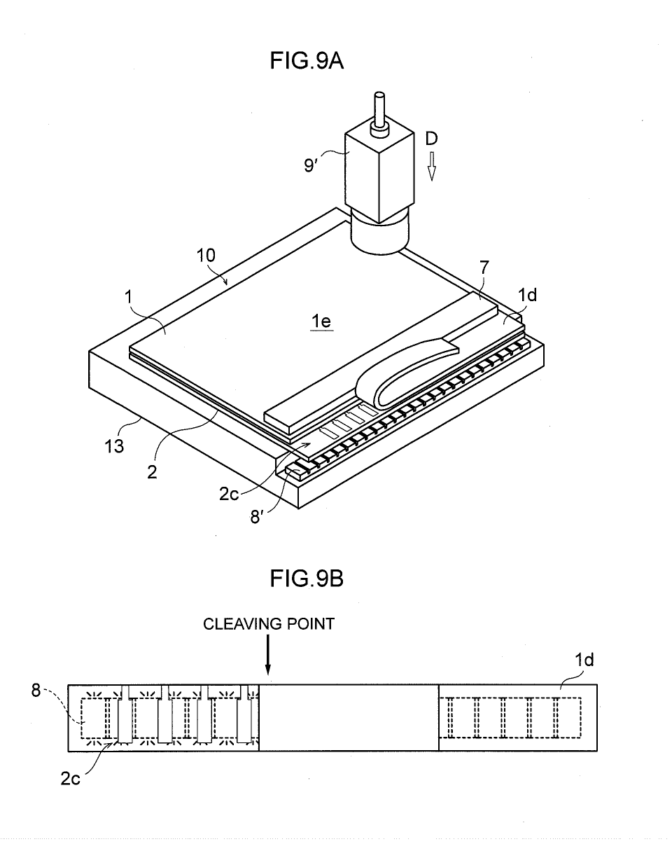

The example of the detection unit is illustrated in FIGS. 8A, 8B, 9A and 9B. FIG. 8A depicts a detection unit that locates a curling-up of the facing section 1d of the film 1 during cleavage in the half-cut line 4, based on an image captured from the side direction C. A camera 9 is disposed at one end wherein the facing section 1d of the film 1 extends, for example, to capture an image of the longitudinal side 1f of the film 1. The image captured by the camera 9 is transmitted to an image processing unit (not illustrated), and the curled-up portion of the facing section 1d is distinguished from the uncurled-up portion. An example of an image captured by the camera 9 is depicted in FIG. 8B.

If the field angle of the camera 9 is wide enough to capture the entire facing section 1d, the border between the curled-up portion and the uncurled-up portion of the facing section 1d is recognized without moving the camera 9. Alternatively, when the field angle of the camera 9 is narrower, the camera 9 may be configured to be horizontally movable along the extending direction of the facing section 1d so as to follow the cleaving point of is the half-cut line 4. In such a case, indicators for identifying the cleaving point, such as markings, numbers, or symbol patterns, may be provided in the working table 13, and the border between the curled-up portion and the uncurled-up portion of the facing section 1d may be detected based on the indicators in the captured image.

Furthermore, a light source 8 (for example, a plane emission-type LED light) may be provided at the location opposing to the camera 9, and may be secured to the working table 13, sandwiching the display device 10. In this configuration, the curled-up portion of the facing section 1d appears as a shadow in an image, and the precision of the image processing can be improved.

The apparatus depicted in FIG. 9A recognizes the curled-up portion of the facing section 1d, based on an image captured from the top direction D. The camera 9′ is disposed vertically above the facing section 1d, for example, to capture an image below it, and to transmit the image to the image processing apparatus. An example of an image captured by the camera 9′ is depicted in FIG. 9B. Note that the camera 9′ may be configured to be horizontally movable along the extending direction of the facing section 1d depending on the field angle, or its position with respect to the working table 13 may be fixed.

Furthermore, the light source 8′ may be provided vertically under the film 2. In this configuration, the border can be precisely detected based on the light amount difference between the curled-up portion and the uncurled-up portion of the facing section 1d (the difference of the transmitting light amount). An example of an image captured by the camera 9′ is depicted in FIG. 9B.

3. Flowcharts

3-1. Manual Control of Air Nozzle

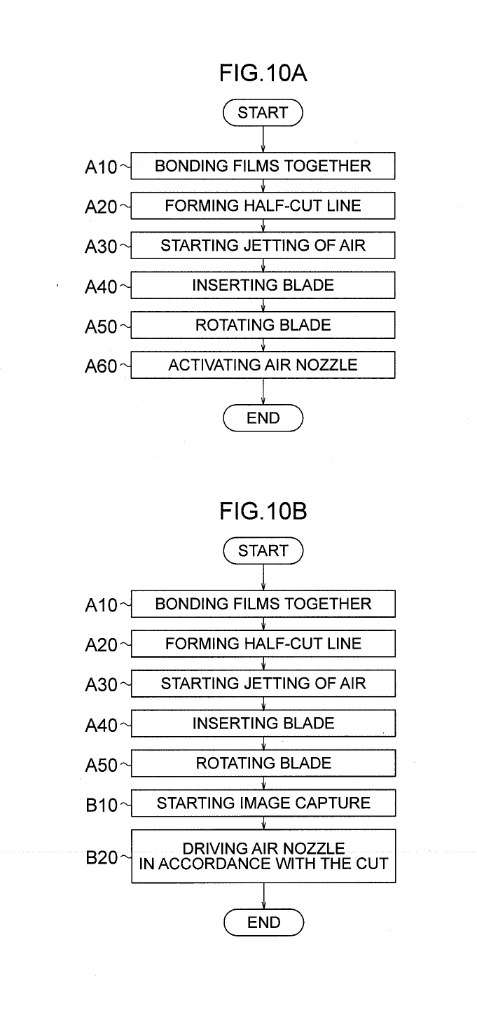

FIG. 10A illustrates steps of cutting a half-cut line 4 to remove facing section 1d in the process for manufacturing a display device 10.

In Step A10 (second step), films 1 and 2 are bonded together, sandwiching a liquid crystal layer 3 to form a display device 10. The display device 10 is then placed on a working table 13 with the outer surface le of the film 1 facing upward, and is secured on the upper surface of the working table 13 while being pressed by the pressing guide 7, except for the facing section 1d.

In Step A20 (first step), the laser irradiation apparatus 14 applies laser light on the outer surface le of the film 1 to form the half-cut line 4. The half-cut line 4 is formed along the outer edge of the facing section 1d of the film 1 that faces the terminal section 2c of the film 2. Step A20 may be performed before Step A10. More specifically, the display device 10 may be formed by bonding the films 1 and 2 each having a half-cut line 4. In this case, Step A10 and Step A20 are reserved in the flowchart.

In Step A30 (fifth step), second air is jetted from the air nozzle 6 along the extending direction of the facing section 1d. The second air widens the gap between the facing section 1d of the film 1 and the terminal section 2c of the film 2 to facilitate the entry of the blade 5 into the gap.

In Step A40 (third step), the blade 5 is inserted into the gap between the facing section 1d and the terminal section 2c. The insertion direction of the blade 5 is vertical to the extending direction of the half-cut line 4, as depicted in FIG. 5. At this time, the blade 5 is maintained to be horizontal so as not to contact the terminal section 2c of the film 2, and the distance d is maintained from the terminal section 2c.

In Step A50 (third step), the blade 5 that has been inserted into the gap is rotated. The blade 5 rotates about the axis P, as depicted in FIG. 5, to the position indicated by the broken line while curling up the facing section 1d of the film 1. While the blade 5 rotates, a tensile force is induced in the thinner portion between the bottom face 4a of the half-cut line 4 and the surface of the facing section 1d and a tear is generated at the end of the half-cut line 4. This tear functions as an initiator to extend a cleavage of the sheet in the half-cut line 4 in the next step. After the tear is generated at the end of the half-cut line 4, the blade 5 may be moved to the position indicated by the solid line in FIG. 5 or may be held in the position indicated by the broken line.

In Step A60 (fourth step), first air is jetted from the air nozzle 6 along the extending direction of the facing section 1d. The first air acts to lengthen the tear generated at the end of the half-cut line 4 in the previous step, and to extend that tear along the half-cut line 4. Thereby, as depicted in FIG. 6, the facing section 1d tears gradually along the half-cut line 4 in the direction of Arrow E to extend the cleavage.

If the cleaving point is drifted from the target of the first air as the tear extends, the depression angle of the air nozzle 6 may be varied manually. For example, the target (aiming point) of the first air is moved along the extending direction of the half-cut line 4, and the jetting direction of the first air is controlled such that the pressure applied to the facing section 1d by the first air is maximized. Thereby, the facing section 1d is peeled off in a short time along the half-cut line 4, curling up the facing section 1d. Once the cleavage extends in the entire length of the half-cut line 4, the facing section 1d is completely removed from the film 1 and the terminal section 2c of the film 2 is exposed.

If the first air jetted in this step is the same as the second air jetted in Step A30, the jetting of the second air in Step A30 may be continued until Step A60. In this case, Step A60 is initiated when a tear is generated in the half-cut line 4 in Step A50, assuming that the steps of extending cleavage is initiated.

3-2. Automatic Control of Air Nozzle

FIG. 10B is the flowchart wherein Step A60 depicted in FIG. 10A is replaced with Steps B10 and B20. This flowchart is for automatic control of the air nozzle 6 by the air nozzle drive mechanism 16. Note that Steps A10 to A50 are similar to those in the above-described flowchart, and thus their description will be omitted.

In Step B10, an image of the facing section 1d at least in the vicinity of the cleaving point is captured by the camera 9 as depicted in FIG. 8A. The captured image, as depicted in FIG. 8B, is transmitted to the image processing apparatus, which recognizes the border between the curled-up portion and the uncurled-up portion of the facing section 1d. Based on the border, the cleaving point of the half-cut line 4 is identified and the horizontal distance L from the initial cleaving point to the cleaving point is calculated.

In Step B20, the depression angle θ of the air nozzle 6 is controlled by the air nozzle drive mechanism 16, based on the horizontal distance L calculated in the previous step. The depression angle θ is controlled so as to be reduced with an increase in the horizontal distance L. Thereby, the target (aiming point) of the air nozzle 6 is displaced to follow the cleaving point of the half-cut line 4. That is, the aiming point of the air nozzle 6 is transferred along the extending direction of the groove, based on the captured image. Not only the shear force induced when the facing section 1d is moved upward, but the tensile force and the shear force induced when the curled-up cleaved portion is blown by the first air are also applied to the cutting section, which extends the tear in a short time. Thereafter, once the facing section 1d is completely removed from the film 1, the terminal section 2c of the film 2 is exposed.

4. Effects

An example of the effects achieved by an example of the above-described embodiment will be discussed.

In the above-described embodiment, the step of removing a facing section 1d is performed after bonding two films 1 and 2. For example, the steps of removing the facing section 1d (Steps A30-A60) are performed after the step of bonding the films 1 and 2 (Step A10). Thereby, deterioration of the rigidity of the films 1 and 2 before bonding can be prevented, and the interconnection lines 1a and the electrode terminals 1b on the transparent electrode layers can be protected more reliably.

Furthermore, in the above-described embodiment, for generating a tear at the end of the half-cut line 4, the blade 5 moves within the vertical plane to the extending direction of the half-cut line 4. The blade 5 does not move in the direction parallel to the extending direction of the half-cut line 4. In this configuration, as depicted in FIG. 5, a tensile force is applied at the end of the half-cut line 4. Unlike the shear force involved in a conventional manufacturing method, for example, this tensile force tends to concentrate on an area with a smaller cross section. Thus, even when the half-cut line is drifted due to some processing error, it is assured that the tensile force is applied in the thinnest portion under the groove. Thereby, a tear is generated precisely and reliably at the end of the half-cut line 4 to remove the facing section 1d. Note that this tear is an initiator for starting peeling off of the facing section 1d.

Particularly, the above-described embodiment is advantageous in that, since the blade 5 is rotated about the axis P, as depicted in FIG. 5, the tensile force acting on the thinner portion between the bottom face 4a of the half-cut line 4 and the surface of the facing section 1d can be enhanced and accordingly a tear can be generated in a short time.

Furthermore, in the above-described embodiment, after generating an initial tear by the blade 5, first air is jetted toward the gap between the facing section 1d and the terminal section 2c from the air nozzle 6. For example, since the tear is already present in Step A60, which has been generated in the previous step, i.e., Step A50, the tensile and shear forces to generate an additional tear is not wanted in Step A60. The tensile and shear forces requested for only lengthening and expanding the cleavage along the half-cut line 4 are sufficient. The force requested for lengthening a tear is generally smaller than the force to generate a new tear, a tear can be extended smoothly in Step A60, without an undue force. In this manner, the tear can be lengthened and extended in a short time.

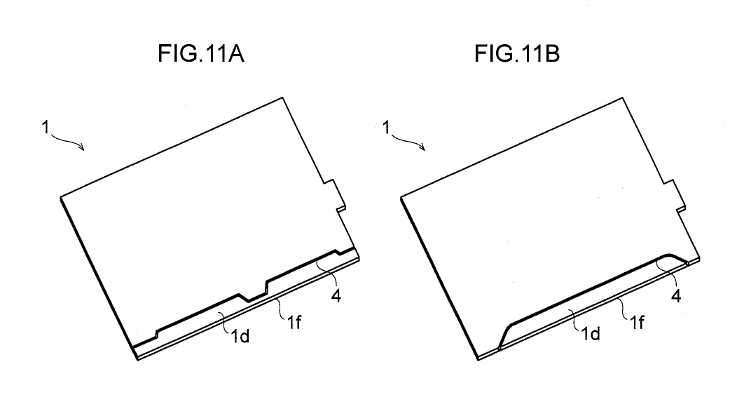

In the above-described embodiment, since the facing section 1d is removed from the film 1 by means of the pressure of the compressed air, the sheet can be precisely cleaved along a half-cut line 4 even that is curved. The facing section 1d can be removed quickly and precisely even in cases where the facing section 1d is partially narrowed by the electrode terminals 1b or the half-cut line 4 is curved at the ends in the extending direction of the facing section 1d, as depicted in FIGS. 11A and 11B, for example. In other words, the distance between the longitudinal side 1f and the half-cut line 4 in the film 1, or the distance between the lateral side 2f and the half-cut line 4 in the film 2 is not requested to be constant.

Furthermore, in the above-described embodiment, since the first air is jetted along the extending direction of the half-cut line 4, the area under half-cut line 4, to which the tensile force and the shear force are applied, can be moved along the extending direction of the half-cut line 4 and accordingly the tear can be easily extended along the half-cut line 4. Thereby, the tear can be lengthened or extended without a cutting tool, and the facing section 1d can be removed and peeled off by means of the pressure of the first air, unlike the conventional manufacturing method, for example. In this manufacturing method, a knife is used only in Step A50 to generate a tear for initiating the cleavage of the sheet in the half-cut line 4.

Furthermore, in the above-described embodiment, before inserting the blade 5 to the gap between the facing section 1d and the terminal section 2c in Step A40, the second air is jetted from the air nozzle 6 to facilitate the entry of the blade 5. This step sequence can help to widen the gap, thereby preventing unintended contact of the blade 5 to the films 1 and 2, to improve the control precision of the blade 5.

No cutting function is needed for the blade 5 of this embodiment, meaning that no sharp edge is needed for the blade 5. Accordingly, the blade 5 may have a shape or material for preventing the electrode terminal 2a from being damaged if the blade 5 contacts the terminal section 2c perchance. Thus, any deterioration of the product quality can be prevented.

During operation of the air nozzle, the facing section 1d can be easily curled up by moving the target (aiming point) of the first air along the half-cut line 4. In such a case, the target may be moved manually or automatically. Thereby, the sheet can be easily cleaved in the half-cut line 4 in a short time, thereby reliably removing the facing section 1d in a short time.

Furthermore, in a configuration wherein the cleaving point of the half-cut line 4 is detected using an image captured by the camera 9 or 9′ as depicted in FIGS. 8A, 8B, 9A and 9B, for example, the jetting direction of the first air can be precisely controlled and the facing section 1d can be reliably removed in a short time.

In this manner, according to the above-described embodiment, both the productivity and quality in the manufacturing process of a display device 10 can be improved.

5. Variants

While a tear is generated at the end of the half-cut line 4 by rotating the blade 5 about the axis P in the above-described embodiment, the displacement of the blade for generating an initial tear is not limited to this movement. For example, by moving the blade 5 vertically upward with respect to the flat surface of the film 2 from the position depicted in the solid line in FIG. 5, a tensile force is also induced in the thinner portion between the bottom face 4a of the half-cut line 4 and the surface of the facing section 1d to generate a tear. Similarly, when a blade 5 has a wedge shape and has a portion thicker than the gap between the two films 1 and 2, by inserting the blade 5 under the facing section 1d while maintaining at least the distance d between the lower face of the blade 5 and the electrode terminals 2b in the film 2, and driving the blade 5 closer to the half-cut line 4, the facing section 1d is driven to contact the upper surface of the blade 5 and is pressed upward, which induces the tensile force in the thinner portion. In other words, unless the direction of displacement of the blade 5 is parallel to the extending direction of the half-cut line 4, a tear can be generated in any case. Therefore, the blade 5 may be displaced in any location as long as the displacement direction includes a component vertical to the extending direction of the half-cut line 4. As used herein, the term “component” refers to a vector component.

Furthermore, as used herein, the term “the direction of displacement of the blade 5” refers to a relative direction with respect to the display device 10 secured on the working table 13. Accordingly, the same effect can be achieved by displacing the display device 10, instead of displacing the blade 5.

Furthermore, while the depression angle θ of the jetting direction of the air nozzle 6 is controlled in accordance with the horizontal distance L in the above-described embodiment, the air nozzle 6 may be slid in the extending direction of the half-cut line 4, instead of changing the depression angle θ. In this configuration, the first air can be blown to the vicinity of the cleaving point, by moving the jetting opening of the air nozzle 6 in accordance with the horizontal distance L, without substantial change of the depression angle θ. Furthermore, control on the pressure applied on the facing section 1d is made possible, which further facilitates removal of the facing section 1d.

In this configuration, a constant distance can be maintained between the jetting opening of the air nozzle 6 and the target (aiming point) of the first air by controlling the position of the jetting opening of the air nozzle 6 by a detection unit as depicted in FIGS. 8A, 8B, 9A and 9B. Thus, the pressure on the facing section 1d can be kept constant if a constant jetting pressure from the air nozzle 6 is maintained. Thereby, the facing section 1d can be removed more quickly and reliably.

Alternatively, instead of displacing the air nozzle 6 in the extending direction of the half-cut line 4, the air nozzle 6 may be secured to the working table 13 and the display device 10 may be displaced in the extending direction of the half-cut line 4 with respect to the air nozzle 6. With this alternative configuration, the target of the first air can be displaced along the half-cut line 4, thereby peeling off the facing section 1d from the film 1.

While the method of manufacturing and the manufacturing apparatus have been described wherein the facing section 1d of the film 1 of two bonded films 1 and 2 of the display device 10 is peeled off in the above-described embodiment, the facing section 2d of the film 2 may also be peeled off and removed simultaneously with the facing section 1d of the film 1. In this case, two pairs of blades 5 and two pairs of air nozzles 6 are provided and disposed such that the jetting directions of air from the respective air nozzles 6 are aligned with the extending directions of half-cut lines 4 in the respective films 1 and 2. Furthermore, the respective blades 5 are disposed so that an initial tear is generated in the respective half-cut lines 4. By locating the pressing guide 7 and shaping the working table 13 so as not to interfere with both the facing section 1d of the film 1 and the facing section 2d of the film 2, the facing section 1d can be peeled off on the upper surface of the film 1, while the facing section 2d is peeled off on the lower face of the film 2.

Note that, with regard to the embodiment and variants described above, various modifications may be made without departing from the spirit of the present disclosure. Constructions and processes of the present embodiment and the variants may be selected or suitably combined where necessary. The embodiment may be practiced or manufactured by those ordinary skilled in the art with reference to the above disclosure.

As described above, the disclosed technique can improve the reliability and yield of a display device.

All examples and conditional language recited herein are intended for pedagogical purposes to aid the reader in understanding the embodiment and the concepts contributed by the inventor to furthering the art, and are to be construed as being without limitation to such specifically recited examples and conditions, nor does the organization of such examples in the specification relate to a showing of the superiority and inferiority of the embodiment. Although the embodiment has been described in detail, it should be understood that the various changes, substitutions, and alterations could be made hereto without departing from the spirit and scope of the embodiment.

What is claimed is:

1. A method of manufacturing a display device comprising a first substrate comprising a conductive layer and a terminal, a second substrate, and a display element disposed between the first substrate and the second substrate, the method comprising:
bonding the first substrate and the second substrate together;
forming a groove in the second substrate, the groove defining a border of a facing section facing the terminal of the first substrate;
inserting a nail member into a gap between the facing section of the second substrate and the terminal of the first substrate, and moving the nail member to a direction including a component in a direction vertical to an extending direction of the groove; and
jetting first gas to the gap.

2. The method according to claim 1, further comprising
rotating the nail member about a rotation axis extending in the extending direction of the groove after inserting the nail member in the gap.

3. The method according to claim 1, wherein
the jetting the first gas comprising jetting the first gas along the extending direction of the groove.

4. The method according to claim 1, further comprising
jetting second gas to the gap before inserting the nail member into the gap.

5. The method according to claim 1, further comprising
moving an aiming point of the first gas along the extending direction of the groove.

6. The method according to claim 5, wherein
the jetting the first gas comprising moving the aiming point in accordance with the groove, based on an image taken for the facing section.

7. The method according to claim 1, wherein
the jetting the first gas comprising transferring jetting opening of an air nozzle of the first gas, along the extending direction of the groove.

8. The method according to claim 7, wherein
the jetting the first gas comprising transferring jetting opening of the air nozzle of the first gas in accordance with the groove, based on an image taken for the facing section.

9. An apparatus for manufacturing a display unit comprising a first substrate comprising a conductive layer and a terminal, a second substrate, and a display element disposed between the first substrate and the second substrate, the apparatus comprising:
a processing unit that forms a groove in the second substrate, the groove defining a border of a facing section facing the terminal of the first substrate;
a nail member configured to be inserted into a gap between the facing section of the second substrate and the terminal of the first substrate, and to be moved to a direction including a component in a direction vertical to an extending direction of the groove; and
a jetting unit that jets first gas to the gap.
